(19) United States
(12) Patent Application Publication
(10) Pub. No.: US 2026/0358162 A1
(43) Pub. Date: Nov. 12, 2026

(54) FEEDER UNIT FOR PASTE-LIKE INGREDIENTS IN ROBOTIC CHEF

(71) Applicant: SAVOREAT LTD., Rehovot (IL)

(72) Inventors: Shai SULTAN, Ganey Tal (IL); Dor JACOBI, Kibbutz Dvir (IL); Yoni SIN REUVEN, Rehovot (IL); Jonathan SASSOON, Ramat Gan (IL)

(73) Assignee: SAVOREAT LTD., Rehovot (IL)

(21) Appl. No.: 19/147,862

(22) PCT Filed: Jan. 16, 2024
(86) PCT No.: PCT/IL2024/050061

§ 371 Date: Jul. 14, 2025

Related U.S. Application Data
(60) Provisional application No. 63/480,184, filed on Jan. 17, 2023.

(51) Int. Cl. G01F 11/02; A47J 44/00

(52) U.S. Cl. CPC G01F 11/029; A47J 44/00

(57) ABSTRACT

A feeder for dispensing a metered amount of a paste-like substance includes: a tubular body configured to receive the paste-like substance; a piston configured to be displaceable within the tubular body; a push plate attached to an end of the piston; and an actuator for displacing the piston in a metered increment, to thereby discharge the substance from the tubular body. The tubular body defines a radial path and the push plate coaxially advances along the radial path. For each feeder, the actuator may include a cam and follower. The cam is configured on a camshaft, and the follower is articulated with the piston. Rotation of the camshaft causes the cam to actuate the follower, thereby advancing the piston. An array of feeders may be arranged colinearly, in which cams of each of the feeders are arranged on a common camshaft. The feeder may be implemented in a robotic chef.

### RELATED APPLICATIONS

This Application claims priority to U.S. Provisional Patent Application No. 63/480,184, entitled “A Feeder Unit and System Comprising Same,” filed Jan. 17, 2023, the contents of which are hereby incorporated by reference as if fully set forth herein.

### TECHNOLOGICAL FIELD

The present disclosure relates to the field of robotic food preparation, and more specifically, but not exclusively, to systems and methods for dispending paste-like materials, such as food materials, within a robotic chef.

### BACKGROUND OF THE INVENTION

A robotic chef is a robot that prepares a meal in an automated manner. Typically, a robotic chef includes repositories for ingredients; devices for performing cooking functions (e.g. stirring, pouring, flipping); platforms or conveyors for conveying the ingredients between the repositories and the cooking apparatus; and a controller for receiving inputs from a consumer regarding desired constitution of food products, and for instructing operation of the various internal components. Robotic chefs have been developed to prepare many different types of meals, including hamburgers, pizza, pasta, and stir fry.

Food dispensing units within robotic chefs are generally configured to dispense raw materials into a central food preparation area. Various types of mechanisms of such dispensing units have been described. These include: removal of an obstruction blocking an opening to the dispenser, to permit ingredients to descend through the opening (U.S. Pat. No. 10,154,762, US 2020/0359845); compression of a bag containing a liquid ingredient, to thereby cause a desired amount of the liquid to flow through a spout (U.S. Pat. No. 10,154,762); laser ablation of a plastic film enclosing raw ingredients, to permit the raw ingredients to be released from the film and dispensed into cooking pots (US 2023/0098024); vertical compression through a dispensing head or nozzle (WO2023/199329); storage of pre-measured quantities of ingredients in small cartridges, and delivering the cartridges through chutes to a central preparation area (US 2023/0346151); screw conveying (US 2022/0338679); and grabbing with a robotic arm (US 2020/0359845).

### SUMMARY OF THE INVENTION

Typically, food dispenser units and the material reservoirs with which they are associated occupy a major volume of any robotic chef. Dispensers used for dispensing heat sensitive materials, such as food products, require even larger spaces as they typically require not only a cooling mechanism, but also sensors which ensure proper storage and dispensing conditions.

In addition, one of the most significant demands for space for dispensing units results from the need for each dispensing unit to have its own dispensing actuator. The requirement of a separate actuator is perceived to be necessary in order to enable metered dosage of each separate ingredient.

In view of these considerations, it is not surprising that many of the dispenser units described in the above-referenced applications above are configured within extremely large robotic kitchens. These robotic kitchens may be, for example, the size of a forty food container truck or an entire room. The need for food dispensing systems that are smaller in size, that can occupy smaller spaces, that may be used as counter-top units, yet which can produce multiple food products at any time, and which incorporate preparing, cooking and dispensing capabilities, remains unmet.

Also, many of the dispensing mechanisms described above are suited for delivery of liquids, large solids, or particulate solids. While it is certainly useful to utilize such ingredients in a robotic kitchen, it is also desirable for a robotic kitchen to dispense a paste-like ingredient. As used in the present disclosure, a food paste is a semi-liquid colloidal suspension, emulsion, or aggregation used in food preparation. Such paste-like ingredients may be used, for example, to prepare a custom-made patty or hamburger substitute. To date, however, no dispensing mechanism has been described that is particularly suited for delivery of a paste-like ingredient.

The present application addresses these and other unmet needs, and discloses dispensing mechanisms that are compact in space and which are effective in delivering metered amounts of materials. The disclosed mechanisms may be incorporated in any food processing system for dispending raw or cooked food components. In particular, the disclosed mechanisms may be used to dispense a metered amount of paste-like materials.

According to a first aspect, a feeder for dispensing a metered amount of a paste-like substance is disclosed. The feeder includes: a tubular body configured to receive the paste-like substance therein; a piston configured to be displaceable within the tubular body; a push plate attached to an end of the piston; and an actuator for displacing the piston in a metered increment within the tubular body, to thereby discharge the paste-like substance from the tubular body. The receiving tubular body defines a radial path and the push plate coaxially advances within the tubular body along the radial path.

Optionally, the radial path defines an arc of up to 60 degrees.

The tubular body may include a dispensing outlet at an end opposite the push plate.

Optionally, the paste-like substance is stored within a container that is insertable within the tubular body. The container may be a flexible sleeve. The container may include a dispensing nozzle configured for true position articulation with respect to a dispensing outlet of the receiving tubular body.

Optionally, the actuator includes a cam and follower. The cam is configured on a camshaft, and the follower is articulated with the piston. Rotation of the camshaft in a first direction causes the cam to actuate the follower, thereby advancing the piston. The follower may include a rod that is secured to the piston and is pivotal about an axis parallel to an axis of rotation of the cam. Rotation of the camshaft in a direction opposite the first direction resets the follower.

In one particular implementation, the cam has a snail shape, wherein the snail shape defines an inner radius, an outer radius, and a leading face between the inner radius and the outer radius. The follower is attached to a rod that is articulated with the piston. Application of pressure with the leading face towards the follower causes rotation of the rod, thereby advancing the piston. Further optionally, a leaf spring is attached to an upper face of the follower. Rotation of the camshaft in a direction opposite the first direction, said opposite direction being a direction of increasing radius of the snail cam, causes raising of the follower against a tension of the leaf spring. Further rotation of the camshaft, past a leading face of the snail cam, causes the follower to drop, in conjunction with release of the tension in the leaf spring, thereby resetting the actuator.

The piston may include an elevational region and pushing region formed at an angle to the elevational region. The elevational region may be substantially s-shaped.

Optionally, the actuator comprises a cam and follower, wherein the cam is configured on a camshaft, and the follower is articulated with the piston, wherein rotation of the camshaft in a first direction causes the cam to actuate the follower, thereby advancing the piston. The camshaft and the dispensing outlet are substantially coplanar, and the push plate is in a plane that is above the plane of the camshaft and outlet. Advantageously, this implementation enables the feeder to be implemented compactly.

In a particularly advantageous embodiment, an array includes a plurality of feeders arranged colinearly. Optionally, for each feeder, the actuator comprises a cam and follower, wherein the cam is configured on a camshaft, and the follower is articulated with the piston, wherein rotation of the camshaft in a first direction causes the cam to actuate the follower, thereby advancing the piston, and the cams of each of the feeders are arranged on a common camshaft. Further optionally, the cams are arranged in relative radial offsets on the camshaft, so that rotation of the shaft actuates only a single feeder at a time. In such embodiments, a single camshaft may be used to actuate multiple feeders, providing significant space savings.

A robotic chef may implement the array. The robotic chef may include other systems and mechanisms, including a cooker mechanism, a controller, and a user input interface.

According to a second aspect, a method of dispensing a metered amount of a paste-like substance is disclosed. The method includes: loading the paste-like substance into a tubular body of a feeder, wherein the feeder comprises a piston configured to be displaceable within the tubular body, a push plate attached to an end of the piston, the receiving tubular body has an arc-shaped cross-section, and the push plate coaxially advances within the tubular body along a radial path. The method further includes advancing the piston within the tubular body with an actuator for displacing the piston in a metered increment within the tubular body, to thereby discharge the paste-like substance from the tubular body. Alternatively, the advancing step may be performed on a feeder in which the paste-like substance has been pre-loaded.

Optionally, the actuator includes a cam and follower, wherein the cam is configured on a camshaft, and the follower is articulated with the piston, wherein rotation of the camshaft in a first direction causes the cam to actuate the follower, thereby advancing the piston. The advancing step comprises rotating the camshaft in the first direction.

Optionally, the cam has a snail shape, wherein the snail shape defines an inner radius, an outer radius, and a leading face between the inner radius and the outer radius. The follower includes a latch that is attached to a rod that is articulated with the piston. The advancing step includes rotating the cam towards the latch when the leading face contacts the latch, thereby rotating the rod, and thereby advancing the piston.

The actuator may further include a leaf spring attached to an upper face of the follower. The method may further include resetting the actuator, the resetting step including: rotating the camshaft in a direction opposite the first direction, said opposite direction being a direction of increasing radius of the snail cam, to thereby raise the follower against a tension of the leaf spring, and further rotating the camshaft, past a leading face of the snail cam, to thereby cause the follower to drop, in conjunction with release of the tension in the leaf spring.

Optionally, the method further includes: loading a plurality of paste-like substances into each of an array of feeders arranged colinearly, wherein each of the cams of the array is arranged on a common camshaft, wherein the cams are arranged in relative radial offsets on the camshaft, so that rotation of the shaft actuates only a single feeder at a time; and rotating the camshaft a plurality of times so as to dispense metered amounts of different substances from the array. Alternatively, the step of rotating the camshaft may be performed on feeders that have been preloaded.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A depicts a perspective view of a feeder, according to embodiments of the present disclosure;

FIG. 1B depicts a cross section view of the feeder of FIG. 1A;

FIG. 2 provides a close-up view of an actuator mechanism of the feeder, according to embodiments of the present disclosure;

FIG. 3 is a cross-section view of the actuator, according to embodiments of the present disclosure;

FIG. 4A is a zoom-in view of a first embodiment of an interface between the piston and the tubular body of the actuator;

FIG. 4B is a zoom-in view of a second embodiment of an interface between the piston and the tubular body of the actuator;

FIG. 5 is a zoom-in view of the dispensing end of the receiving tubular body, according to embodiments of the present disclosure;

FIGS. 6A-6C illustrate a progression of views as the actuator dispenses a paste-like material from the feeder, according to embodiments of the present disclosure;

FIG. 7 illustrates an array of feeders arranged colinearly, according to embodiments of the present disclosure;

FIG. 8 illustrates a crank shaft unit for the array of feeders of FIG. 7, according to some embodiments of the invention;

FIG. 9A and FIG. 9B depict a process of removal and replacement of a raw food container from one of the feeders of the array of FIG. 7; and

FIG. 10 depicts a robotic chef incorporating the array of feeders of FIG. 7, according to embodiments of the present disclosure.

### DETAILED DESCRIPTION OF EMBODIMENTS

The present disclosure relates to the field of robotic food preparation, and more specifically, but not exclusively, to systems and methods for dispending paste-like materials, such as food materials, within a robotic chef.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

As used in the present disclosure, the terms “feeder” and “feeder mechanism” are equivalent, and refer to a mechanical device used for storage and delivery of a metered amount of an ingredient from a receptacle. As used in the present disclosure, the terms “actuator” and “actuating mechanism” are equivalent, and refer to a mechanical component, or a series of mechanical components operating together, configured to dispense the metered amount of the ingredient from the feeder.

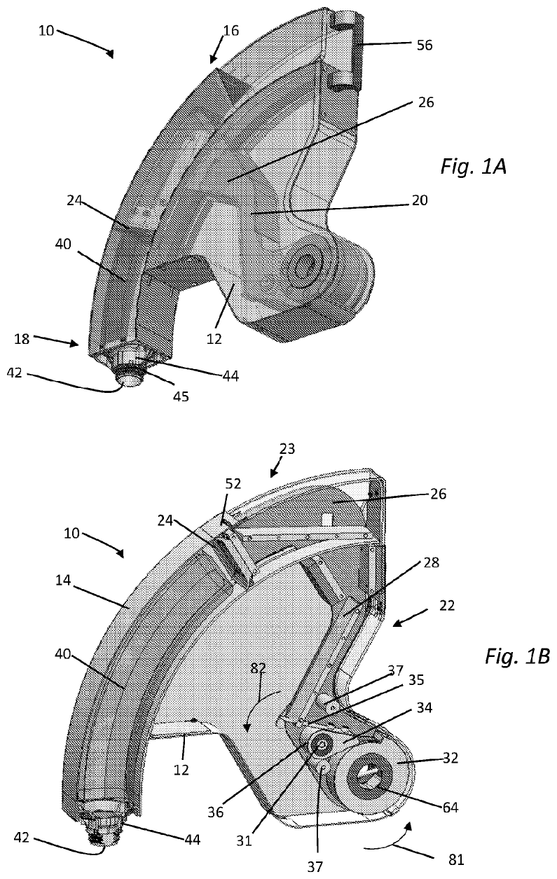

FIGS. 1A-B provide depictions of an embodiment of a feeder 10. Feeder 10 includes a receiving tubular body 14 with a back end 16 and a dispensing outlet 18. In the illustrated embodiment, the receiving tubular body 14 defines a radial or arc-shaped path. This arrangement is advantageous for ensuring that the feeder is compact. In the plane of movement, receiving tubular body 14 may have any suitable cross-section, such as cylindrical, spherical, square, rectangular, or polygonal.

Removable container 40 is optionally insertable into the feeder 10. Container 40 may contain a raw food ingredient, such as a paste-like substance. The container 40 may be a flexible sleeve. Container 40 includes a dispensing nozzle 42 that is configured to true position articulation (i.e., may be aligned and fixed) relative to opening 45 of a dispensing cap 44 of the dispensing outlet 18. The dispensing cap 44 may be removably fixed within the dispensing outlet 18 through any suitable mechanism, such as a snap-fit mechanism. When the flexible sleeve of the container 40 is compressed, the increase in pressure causes dispensing of the contents of the container 40 through dispensing nozzle 42. Feeder 10 further includes a handle 56. The handle is used during the process of removing and replacing containers 40, as will be described further herein. The use of a container 40 is desirable for purposes of easy replacement and cleaning, as well as for ensuring that the raw food ingredient does not spread to other parts of the feeder 10.

Feeder 10 further includes a piston 20 that is coaxially displaceable within the receiving tubular body 14. Piston 20 includes outer walls 26. In the illustrated embodiment, the outer walls 26 comprise parallel plates that are held together, inter alia, by pins 37. Alternatively, the piston 20 may be partially or entirely solid. The outer walls 26 define an elevational region 22, extending vertically in the view of FIG. 1B, and a pushing region 23, extending horizontally in the view of FIG. 1B. In the illustrated embodiment, the outer walls 26 of the elevational region 22 and pushing region 23 are formed of integral pieces. The elevational region 22 may be substantially s-shaped, as depicted, or otherwise curved or linear. The pushing region 23 is formed at an angle to the elevational region 22. Advantageously, this configuration of the elevational region 22 and pushing region 23 enables a rotational force that is applied to the bottom of the elevational region 22 to be transferred to the push plate 24, as will be described further herein.

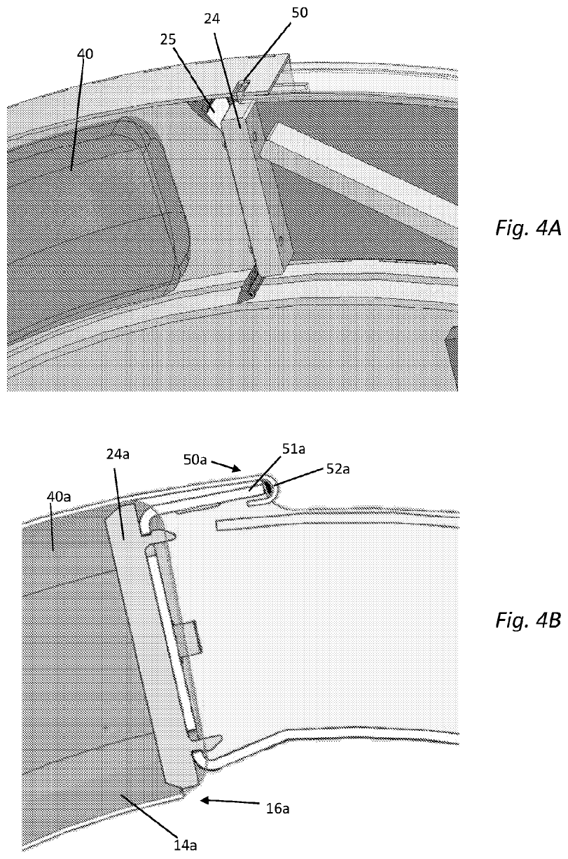

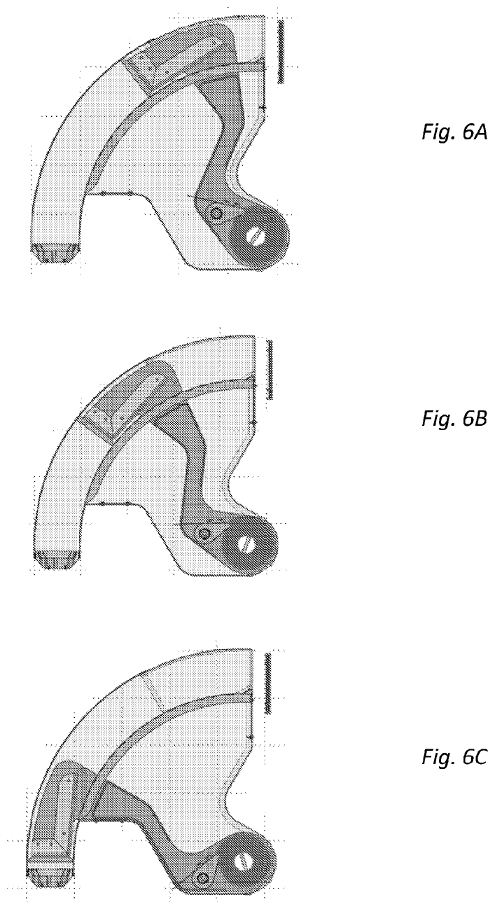

An actuator is configured for displacing the piston 20 in a metered increment within the tubular body 14, to thereby discharge the raw food ingredient from the tubular body 14. The actuator displaces the piston 20 between a retracted position, at which the push plate 24 is near the back end 16 of the receiving tubular body 14, and a discharged position at which the push plate 24 is near the dispensing outlet 18 of the receiving tubular body 14. The push plate 24 is snugly displaceable within the receiving tubular body 14. Optionally, a molded piece 25 (shown in FIG. 4A) is attached to the front of push plate 24, to distribute the force generated by push plate 24 toward edges of the receiving tubular body 14. Because the receiving tubular body 14 has an arc-shaped cross-section, the push plate 24 coaxially displaces within the receiving tubular body 14 along a radial path. In exemplary embodiments, the radial path defines an arc between a minimal path (slightly above 0 degrees) and 60 degrees. In the illustrated embodiment, the arc defines a radial path of 60 degrees. The length of the radial path may be influenced by the number of feeders 10 that are arranged in a colinear array, in which the sum total of the radial paths of all the feeders in the array cannot exceed 360 degrees, as will be discussed further herein. As the push plate 24 displaces, the elevational region 22 of the piston 20 correspondingly radially displaces within internal space 12 of feeder 10. The progression of displacement of the push plate 24 and elevational region 22 is shown in FIGS. 6A-6C. In FIG. 6A, the piston 20 is in a position of maximal retraction. In FIG. 6B, the piston 20 has displaced approximately half the volume of the receiving tubular body 14, and in FIG. 6C, the piston 20 has displaced the entire volume of the receiving tubular body 14.

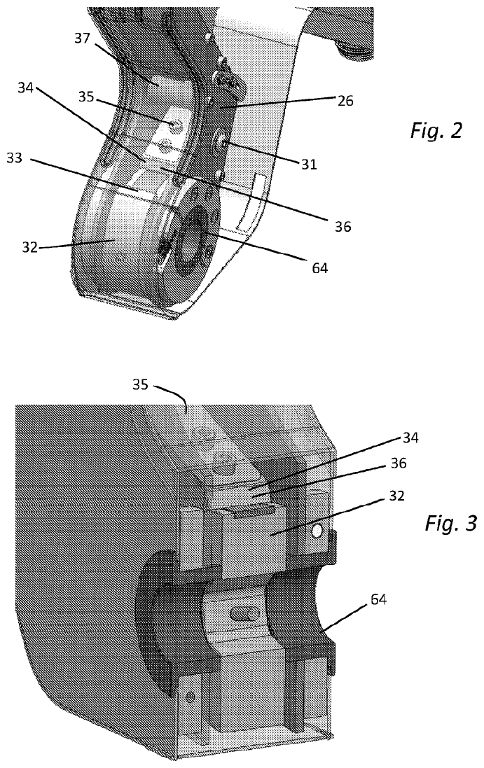

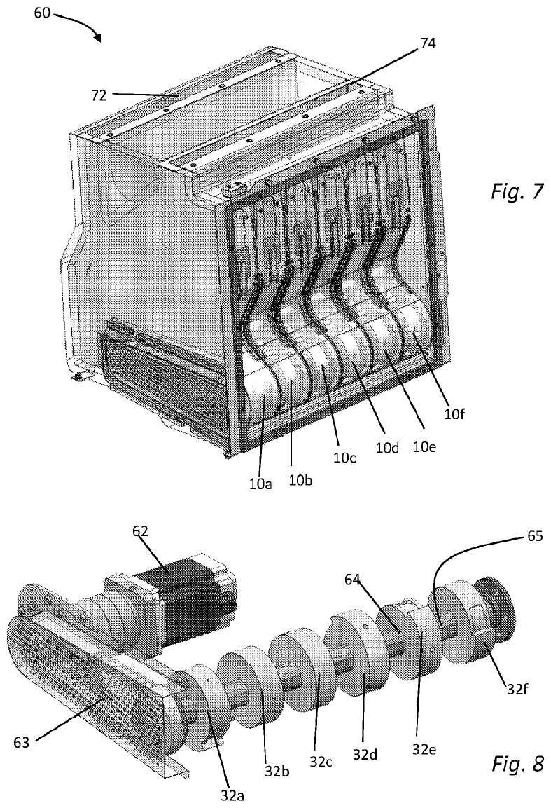

FIG. 2 illustrates a close-up view of the actuating mechanism, and FIG. 3 illustrates a cross-section view of certain elements of the actuating mechanism. In the illustrated embodiments, the actuating mechanism includes a cam and follower mechanism. Cam 32 has a snail shape (also known as a drop shape), including an inner radius, an outer radius, and a leading face 33 between the inner radius and the outer radius. The cam is rotatable through rotation of rings 64, which are secured around a camshaft. One exemplary camshaft will be described further herein in connection with FIGS. 7 and 8. The follower 36 is a latch that is configured to be actuated through movement of the cam 32, as will be described further herein. In the illustrated embodiment, follower 36 is teardrop shaped. The tip 34 of the tear drop has approximately the same dimensions as the leading face 33 of cam 32. In addition to being actuatable by the cam 32, follower 36 is articulated with the piston 20. In the embodiment illustrated here, rod 31 passes through both follower 36 and the outer walls 26 of piston 20, and thus rod 31 translates radial force from the follower 36 to the piston 20. Rod 31 is secured to the piston 20 and is pivotal about an axis that is parallel to an axis of rotation of the cam 32. Leaf spring 35 is fixed to the follower 36 and is compressible against a front face of the piston 20 (as illustrated in FIG. 1B) or, alternatively, against the upper pin 37.

When the cam 32 is rotated in the direction of arrow 81 of FIG. 1B (counterclockwise in the view of FIG. 1B), and the leading face 33 contacts tip 34, the rotational force of the cam 32 causes force to be applied on the follower 36 in the direction of arrow 82 of FIG. 1B. This rotational force is translated to the rod 31 that is embedded within the follower, and from the rod 31 to the walls 26 of the piston 20, and to the push plate 24. As a result, the push plate 24 is advanced forwards radially within tubular body 14, as the elevational region 22 is advanced within internal space 12. Continued application of pressure from cam 32 causes the entire follower 36 to descend within feeder 10, and, correspondingly, causes the push plate 24 to continue to advance within tubular body 14. The point of contact of the leading face 33 and tip 34 correspondingly rotates. This may be viewed through comparison of the location of rod 31 in FIG. 6A, in which the piston 20 is in the most retracted position, versus FIG. 6B, in which the piston 20 has been actuated to the midpoint of the potential advancement. When the piston 20 has advanced to the furthest point of advancement, as shown in FIG. 6C, the follower 36 is near the very bottom of the interior space 12 of the feeder 10.

The degree of advancement of the piston 20 may be controlled through control of the angular rotation of the camshaft. As a result, the actuator may be configured to displace the piston 20 in metered increments, and, correspondingly, to dispense a metered amount of food product ingredient from the tubular body 14.

The actuator may be reset by rotating the cam 32 in the opposite direction (clockwise in the view of FIG. 1B). When the cam 32 is rotated in the opposite direction, the cam 32 and follower 36 operate in the manner of a classic snail cam mechanism. Specifically, follower 36 is raised and lowered along the outer radius of the cam 32, and “drops” when the cam 32 is rotated past the leading face 33. The rise of the follower 36 is counterbalanced by tensioning of leaf spring 35. When the follower 36 drops, the release of the tension of the leaf spring 35 helps ensure that the follower 36 returns to the same position as it was prior to being raised. As a result, the raising and lowering of the follower 36 has no bearing on the positioning of the piston 20 within the tubular body 14. The piston 20 is thus placed again in position to continue dispensing the ingredient, upon rotation of the camshaft in the initial direction.

It should be noted that, when the feeder 10 is configured in a standalone manner, as illustrated in FIGS. 1A and 1B, there is no particular need to reset the actuator. This is because, following every metered displacement of the piston 20, the cam 32 remains in contact with tip 34 and in position to continue displacing piston 20. Resetting the actuator is useful, however, in embodiments in which multiple feeders 10 share a common crankshaft, as will be described further herein.

FIG. 4A illustrates a close-up view of the connection point between piston 20 and tubular body 14. A stop mechanism 50 may be provided, e.g., for preventing unintentional withdrawal of the piston 20 from the receiving tubular body 14. The stop mechanism 50 is configured for engaging the receiving tubular body 14 with the piston 20. The stop mechanism 50 arrests the receiving tubular body 14 when the piston 20 reaches a fully retracted position.

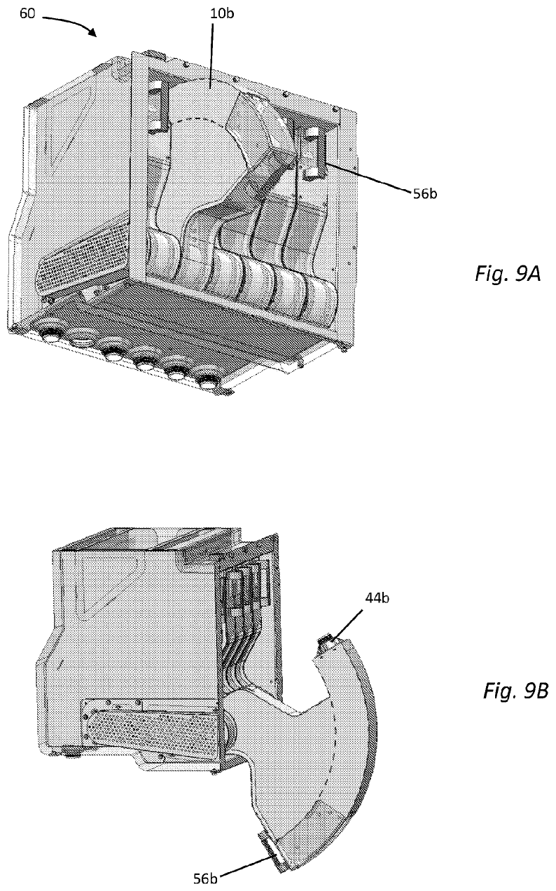

In the mechanism for loading the tubular body 14 described in FIGS. 9A and 9B, a container 40 is inserted into the dispensing end 18 of the tubular body 14. In such embodiments, it is never necessary to withdraw the piston 20 from the tubular body 14, not even to load a container 40. Accordingly, the stop mechanism 50 is configured as a tab, to ensure that, when the piston 20 is retracted, that the piston 20 is not removed entirely from tubular body 14. In another possible mechanism, illustrated in FIG. 4B, a container 40a is inserted into the tubular body 14a from retracted end 16a. In such embodiments, the piston 20a is removed from the tubular body 14a. In such a mechanism, the stop may be replaced with an openable locking mechanism 50a. Clasp 52a is configured to releasably arrest latch 51a, located at a front end of the piston 20.

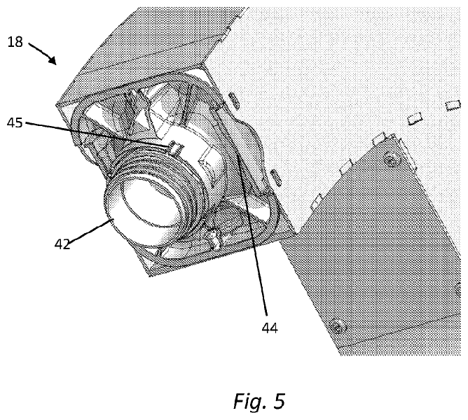

FIG. 5 illustrates a close-up view of the dispensing outlet 18. Dispensing cap 44 is inserted into the dispensing outlet 18, through any suitable mechanism, such as a snap fit. The container 40 has a dispensing nozzle 42. The dispensing nozzle 42 may be securely and removably fixed, in true position articulation, within opening 45 of the dispensing cap 44. The dispensing nozzle 42 may be a substantially rigid element and comprise a positioning collar for arresting by the opening 45 of dispensing cap 44. The opening 45 may have a keyhole shape, with a wider insertion opening and a smaller fixing opening configured for arresting the positioning collar of the dispensing nozzle 42.

The specific configuration of the dispensing nozzle 42 may vary depending on the type of food ingredient or material that is dispensed from the feeder 10. In one preferred embodiment, the food ingredient is a food paste or paste-like material. Advantageously, in such embodiments, the viscosity of the paste is sufficient to ensure that the paste does not exit the nozzle 42, even when the nozzle 42 is oriented in a downward position, until the feeder 10 is actuated. In addition or in the alternative, the feeder 10 may be used to dispense liquids or granular solids, so long as the nozzle 42 is equipped with a suitable valve to ensure that only the desired volume of ingredient is dispensed.

As described above, the feeder 10 may be configured as an independent structure, for dispensing a single type of food product ingredient. This structure alone has various advantages. In particular, the camshaft and the dispensing outlet 18 are substantially coplanar, and the push plate 24 is in a plane that is above the plane of the camshaft and outlet. As a result, this arrangement is particularly suited for a compact three-dimensional arrangement of the feeder, specifically one having limited height.

Additional space-saving advantages may be realized when the feeder 10 is arranged as an array of feeders 10 sharing a common camshaft, as illustrated in FIG. 7.

Referring now to FIG. 7, an array 60 may include a plurality of feeders 10a-10f arranged colinearly. The array 60 may be configured within a cooled ingredient storage portion of a robotic chef. This ingredient storage section may include, for example, cooled air inlet 72 and warm air outlet 74.

FIG. 8 illustrates a motor for concerted actuation of each of the feeders 10a-10f. The motor includes motor drive 62, transmission 63, and camshaft 65. Through the transmission 63, rotation of the motor drive 63 causes rotation of the camshaft 65. The cams 32a-32f of each of the feeders 10a-10f are attached to the camshaft 65 at rings 64. Notably, the cams are affixed to the camshaft 65 at an angular offset. This angular offset may be set according to the number of cams that are configured around the camshaft 65. In the illustrated embodiment, the six cams are offset at 60 degree angles, so that the entire 360 degree range of the camshaft may be utilized. For example, cam 32a may be configured in a dispensing position (contacting the tip of the corresponding follower) when the crank is at angles 0° to 60°; cam 32b may be in a dispensing position from angles 60° to 120°; cam 32c, from angles 120° to 180°; cam 32d, from angles 180° to 240°; cam 32e, from angles 240° to 300°; and cam 32f, from angles 300° to 360°. Obviously, if there are fewer or more than six cams, the offsets may be set to different values, so as to utilize the entire angular range of the camshaft.

Preferably, the angular range of the arc of each receiving tubular body 14 is no greater than the angular offset between each cam 32 on the camshaft 65. Thus, if the angular offset is 60°, and the arc of each receiving tubular body 14 is also 60°, then it is possible to empty each tubular body 14 without actuating a different cam 32. By contrast, if the angular offset is less than 60° while the arc of the tubular body is 60° or more, then emptying one tubular body 14 would not be possible without unintentionally also dispensing some food product from a different tubular body. If the angular offset is greater than the arc of the corresponding tubular body, it would be possible to empty the tubular body as desired, although some of the camshaft 65 would not be utilized.

Using the shared camshaft, it is possible to actuate and reset the feeders sequentially, in order to dispense any combination of the ingredients, and in any order.

By way of example, suppose that it is desired to output three ingredients, which are stored in feeders 10a, 10b, and 10f. Further suppose that each of the feeders are full, and that the angular offset of each cam is 60 °C. Furthermore, suppose that it is desired to extrude a volume corresponding to one-twelfth ( 1/12) of the contents of each container 40 from its respective feeder 10. This one-twelfth corresponds to 5 degrees of rotational arc. Accordingly, in a first step, the camshaft is rotated backwards until cam 32a is adjacent to the tip of the corresponding latch. As discussed above, the backwards rotation merely raises and lowers the latches, with the assistance of the leaf springs, but does not change the position of the pistons. The camshaft is then advanced forwards 5°. This causes the desired amount of raw food product to be extruded from feeder 10a. Because the cams of the other feeders are not adjacent to the corresponding latches, nothing is extruded from those feeders. Then, the camshaft 65 is rotated backwards until it reaches the 60° mark. Camshaft 65 is rotated forwards 5°, thereby extruding the food product from feeder 10b. Camshaft 65 is rotated backwards once again until it reaches the 300° mark, and then rotated forwards 5°, to extrude the food product from feeder 10f.

The array 60 may be equipped with a controller (not shown). The controller not only controls the operation of motor 62 for forwards and backwards movement, as discussed, but may also have a memory. This memory, inter alia, may record the prior actuations of each feeder 10, to ensure that the camshaft 65 is set to the right angular location in order to effect subsequent actuations of that feeder. Thus, in the example given above, should it be desired to dispense another volume of the ingredient from feeder 10a corresponding to 5° of angular extent, the controller causes motor 62 to rotate the camshaft 65 backwards until it reaches the 5° mark, and then forwards from the 5° mark to the 10° mark. In addition or in the alternative to the mechanism described above, a load cell or other weight sensor may also be used to track either the volume of dispensed ingredient or the volume of remaining ingredient. The controller or other suitable sensor may likewise be used to track when a feeder is empty, such that the container needs to be replaced.

FIGS. 9A-9B illustrate a process of replacing and loading a new container 40 into a respective feeder. In the illustrated embodiment, feeder 10b is in the array 60 of FIG. 7. As shown in FIG. 9A, a user grasps the handle 56b of feeder 10b. Feeder 10b, which is arranged on a hinge, is withdrawn downwards and backwards. This exposes the dispensing cap 44b. The piston, which may have been previously advanced to its furthest point of advancement, falls backwards due to gravity. The user removes the dispensing cap 44b from the tubular body 14 (for example, by squeezing flexible ends of the dispensing cap 44b to release the snap fit). The user then removes the nozzle of the used container from the opening of the dispensing cap, securely places the nozzle of the new container into the opening of the new dispensing cap, loads the new container into the dispensing end of the tubular body, and secures the dispensing cap into the tubular body. It should be noted that the feeders 10 of the present disclosure may be supplied in a pre-loaded manner, such that, at least initially, the user using does not load the container 40 into the feeder 10 prior to use.

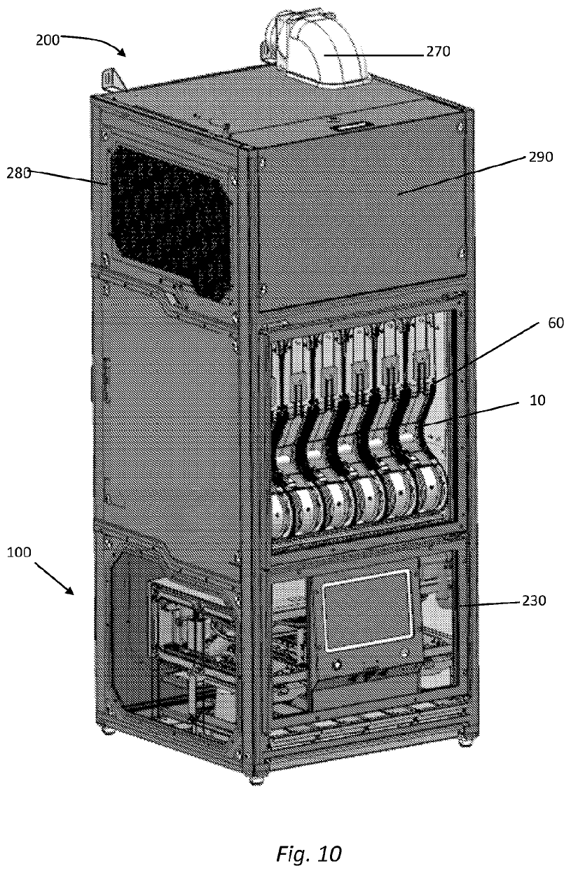

FIG. 10 illustrates an embodiment of robotic chef 200 that may incorporate array 60 of feeders 10. The robotic chef 200 includes other modules and stations for food preparation and proper functioning, including cooking station 100, a cooling system 280, an electrical box 290, a chimney 270, and an input interface 230. That said, the feeder 10 and array 60 described herein may be incorporated into various robotic chefs having different configurations, or various other types of machines.

1.-23. (canceled)

24. A feeder for dispensing a metered amount of a paste-like substance, comprising:
a tubular body configured to receive the paste-like substance therein;
a piston configured to be displaceable within the tubular body;
a push plate attached to an end of the piston;
and an actuator for displacing the piston in a metered increment within the tubular body, to thereby discharge the paste-like substance from the tubular body;
wherein the receiving tubular body defines a radial path and the push plate coaxially advances within the tubular body along the radial path.

25. The feeder of claim 24, wherein the paste-like substance is stored within a container that is insertable within the tubular body.

26. The feeder of claim 25, wherein the container is a flexible sleeve.

27. The feeder of claim 25, wherein the tubular body comprises a dispensing outlet at an end opposite the push plate, and the container comprises a dispensing nozzle configured for true position articulation with respect to the dispensing outlet of the receiving tubular body.

28. The feeder of claim 24, wherein the actuator comprises a cam and follower, wherein the cam is configured on a camshaft, and the follower is articulated with the piston, wherein rotation of the camshaft in a first direction causes the cam to actuate the follower, thereby advancing the piston.

29. The feeder of claim 28, wherein the follower comprises a rod that is secured to the piston and is pivotal about an axis parallel to an axis of rotation of the cam.

30. The feeder of claim 28, wherein rotation of the camshaft in a direction opposite the first direction resets the follower.

31. The feeder of claim 28, wherein the cam has a snail shape, wherein the snail shape defines an inner radius, an outer radius, and a leading face between the inner radius and the outer radius; and wherein the follower is attached to a rod that is articulated with the piston; wherein, application of pressure with the leading face towards the follower causes rotation of the rod, thereby advancing the piston.

32. The feeder of claim 31, further comprising a leaf spring attached to an upper face of the follower, wherein rotation of the camshaft in a direction opposite the first direction, said opposite direction being a direction of increasing radius of the snail cam, causes raising of the follower against a tension of the leaf spring, and further rotation of the camshaft, past a leading face of the snail cam, causes the follower to drop, in conjunction with release of the tension in the leaf spring, thereby resetting the actuator.

33. The feeder of claim 24, wherein the piston comprises an elevational region and pushing region formed at an angle to the elevational region.

34. The feeder of claim 33, wherein the elevational region is substantially s-shaped.

35. The feeder of claim 24, wherein the actuator comprises a cam and follower, wherein the cam is configured on a camshaft, and the follower is articulated with the piston, wherein rotation of the camshaft in a first direction causes the cam to actuate the follower, thereby advancing the piston; wherein the tubular body comprises a dispensing outlet at an end opposite the push plate, and
wherein the camshaft and the dispensing outlet are substantially coplanar, and the push plate is in a plane that is above the plane of the camshaft and dispensing outlet.

36. An array comprising a plurality of the feeders of claim 24 arranged colinearly, wherein, for each feeder, the actuator comprises a cam and follower, wherein the cam is configured on a camshaft, and the follower is articulated with the piston, wherein rotation of the camshaft in a first direction causes the cam to actuate the follower, thereby advancing the piston, and
the cams of each of the feeders are arranged on a common camshaft.

37. The array of claim 36, wherein the cams are arranged in relative radial offsets on the camshaft, so that rotation of the camshaft actuates only a single feeder at a time.

38. A method of dispensing a metered amount of a paste-like substance, comprising:
loading the paste-like substance into a tubular body of a feeder, wherein the feeder comprises a piston configured to be displaceable within the tubular body, a push plate attached to an end of the piston, the receiving tubular body has an arc-shaped cross-section, and the push plate coaxially advances within the tubular body along a radial path; and
advancing the piston within the tubular body with an actuator for displacing the piston in a metered increment within the tubular body, to thereby discharge the paste-like substance from the tubular body.

39. The method of claim 38, wherein the actuator comprises a cam and follower, wherein the cam is configured on a camshaft, and the follower is articulated with the piston, wherein rotation of the camshaft in a first direction causes the cam to actuate the follower, thereby advancing the piston, and the advancing step comprises rotating the camshaft in the first direction.

40. The method of claim 39, wherein the cam has a snail shape, wherein the snail shape defines an inner radius, an outer radius, and a leading face between the inner radius and the outer radius; and wherein the follower comprises a tip that is attached to a rod that is articulated with the piston; and wherein the advancing step comprises rotating the cam towards the tip when the leading face contacts the tip, thereby rotating the rod, and thereby advancing the piston.

41. The method of claim 39, wherein the actuator further comprises a leaf spring attached to an upper face of the follower, and the method further comprises resetting the actuator, said resetting step comprising: rotating the camshaft in a direction opposite the first direction, said opposite direction being a direction of increasing radius of the snail cam, to thereby raise the follower against a tension of the leaf spring, and further rotating the camshaft, past a leading face of the snail cam, to thereby cause the follower to drop, in conjunction with release of the tension in the leaf spring.

42. The method of claim 38, further comprising:
loading a plurality of paste-like substances into each of an array of feeders arranged colinearly, wherein each of the cams of the array is arranged on a common camshaft, wherein the cams are arranged in relative radial offsets on the camshaft, so that rotation of the shaft actuates only a single feeder at a time; and
rotating the camshaft a plurality of times so as to dispense metered amounts of different substances from the array.
